(19) United States
(12) Patent Application Publication
(10) Pub. No.: US 2008/0007548 A1
(43) Pub. Date: Jan. 10, 2008

(54) Image display apparatus, and method for removing discharge of the same

(75) Inventor: Joung-hyun Yeo, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/702,492

(22) Filed: Feb. 6, 2007

(30) Foreign Application Priority Data
Jul. 10, 2006 (KR) 10-2006-0064530

(51) Int. Cl. G06F 3/038

(52) U.S. Cl. 345/212

(57) ABSTRACT

An image display apparatus and a method for removing discharge of the same are provided. The image display apparatus includes: a driving voltage adjusting unit that adjusts a driving voltage according to a selected discharge removal value; a ramp voltage adjusting unit for adjusting a ramp voltage according to the selected discharge removal value; and a controller for generating a discharge removal menu when a discharge removal menu display command is inputted, and controlling any one of the driving voltage adjusting unit and the ramp voltage adjusting unit to remove discharge according to the discharge removal value selected from the discharge removal menu.

### CROSS-REFERENCE TO RELATED APPLICATIONS

This application claims priority from Korean Patent Application No. 10-2006-064530, filed Jul. 10, 2006, in the Korean Intellectual Property Office, the entire disclosure of which is hereby incorporated by reference.

### BACKGROUND OF THE INVENTION

1. Field of the Invention

Apparatuses and methods consistent with the present invention relate to an image display and removing discharge of the same. More particularly, the present invention relates to an image display and removing discharge of the same, which can display an abnormal discharge removal menu if abnormal discharge is generated.

2. Description of the Related Art

A plasma display panel (PDP), which is one example of an image display apparatus, is a flat display apparatus which displays characters or images by using plasma generated by gas discharge. A few tens to a few millions pixels are arranged in a matrix shape according to the size of the plasma display apparatus. The pixels selectively emit light to display characters or images.

Specifically, in the plasma display apparatus, Y electrodes and Z electrodes are formed on the same surface of a front substrate, X electrodes are formed on a rear substrate of an upper structure, barrier ribs are formed between the X electrodes to prevent crosstalk with the adjacent cells, and a phosphor layer is formed on a lower structure around the barrier ribs and the X electrodes. An inert gas is injected into the space between the upper and lower structures, for forming a discharge region.

In the plasma display apparatus, when a driving voltage is applied between the X electrodes and the Y electrodes, facing discharge occurs between the X electrodes and the Y electrodes, to generate wall charges. When discharge voltages having opposite polarities are continuously applied to the Y electrodes and the Z electrodes and the driving voltage applied to the X electrodes is intercepted, a potential difference is maintained between the Y electrodes and the Z electrodes by the wall charges, thereby generating surface discharge. As a result, ultraviolet rays are generated from the inert gas of the discharge region. The phosphor layer is excited by the ultraviolet rays. The radiating phosphor layer performs color display.

In the plasma display apparatus, the materials for self light emission are chemically coupled, and thus internal characteristics are slightly changed by the using period. In the case that a user uses the plasma display apparatus for a long time, abnormal discharge may occur due to the changes. Since the images are displayed by using discharge, the displayed images are affected by the abnormal discharge.

In a related art image display, even if the abnormal discharge is generated in the plasma display apparatus, the plasma display apparatus cannot automatically remove the abnormal discharge and the user cannot directly remove the abnormal discharge. That is, when the abnormal discharge occurs, the user must request a repair service. A repairman visiting the home of the user disassembles the plasma display apparatus to remove the abnormal discharge.

Accordingly, when the abnormal discharge occurs in the plasma display apparatus, the user spends a lot of time and cost removing the abnormal discharge. That is, it causes great inconvenience to the user.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention is achieved to address the above problems. The present invention provides an image display apparatus and a method for removing discharge of the same which can display a discharge removal menu so that a user can directly remove the discharge.

According to an aspect of the present invention, there is provided an image display apparatus, including: a driving voltage adjusting unit for adjusting a driving voltage according to a selected discharge removal value; a ramp voltage adjusting unit for adjusting a ramp voltage according to the selected discharge removal value; and a controller for generating a discharge removal menu when a discharge removal menu display command is inputted, and controlling any one of the driving voltage adjusting unit and the ramp voltage adjusting unit to remove discharge according to the discharge removal value selected from the discharge removal menu.

The image display apparatus further includes an on-screen display (OSD) generating unit for generating and displaying the discharge removal menu.

In an exemplary embodiment, the image display apparatus further includes a key input unit that has any one of a key for selecting the discharge removal menu on a menu screen, a special discharge removal menu key, and a key for selecting the discharge removal value.

In an exemplary embodiment, the discharge removal menu includes a discharge removal adjusting bar for adjusting the discharge removal value.

In an exemplary embodiment, the discharge removal adjusting bar has an adjusting range corresponding to a variable range of a discharge removing element.

In an exemplary embodiment, the discharge removing element is at least one of a driving voltage, a boosting ramp voltage for adjusting a boosting ramp gradient, and a dropping ramp voltage for adjusting a dropping ramp gradient.

According to an aspect of the present invention, there is provided a method for removing discharge of an image display apparatus, including: displaying a discharge removal menu if a discharge removal menu display command is inputted; and removing discharge according to a discharge removal value selected from the discharge removal menu.

In an exemplary embodiment, the discharge removal menu includes a discharge removal adjusting bar for adjusting the discharge removal value.

In an exemplary embodiment, the discharge removal adjusting bar has an adjusting range corresponding to a variable range of a discharge removing element.

In an exemplary embodiment, the discharge removing element is at least one of a driving voltage, a boosting ramp voltage for adjusting a boosting ramp gradient, and a dropping ramp voltage for adjusting a dropping ramp gradient.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram illustrating a plasma display apparatus in accordance with an exemplary embodiment of the present invention;

FIG. 2 is a flowchart showing sequential steps of a method for removing discharge of the plasma display apparatus in accordance with an exemplary embodiment of the present invention;

FIG. 3A is an exemplary diagram illustrating one example of a method for displaying a discharge removal menu in accordance with an exemplary embodiment of the present invention;

FIG. 3B is an exemplary diagram illustrating another example of the method for displaying the discharge removal menu in accordance with an exemplary embodiment of the present invention; and

FIG. 3C is an exemplary diagram illustrating one example of a method for displaying a discharge removal adjusting bar in accordance with an exemplary embodiment of the present invention.

### DETAILED DESCRIPTION OF THE EXEMPLARY EMBODIMENTS OF THE INVENTION

Certain exemplary embodiments of the present invention will now be described in greater detail with reference to the accompanying drawings.

In the following description, same drawing reference numerals are used for the same elements even in different drawings. The matters defined in the description such as a detailed construction and elements are provided to assist in a comprehensive understanding of the invention. Thus, it is apparent that the present invention can be carried out without those defined matters. Also, well-known functions or constructions are not described in detail since they would obscure the invention in unnecessary detail.

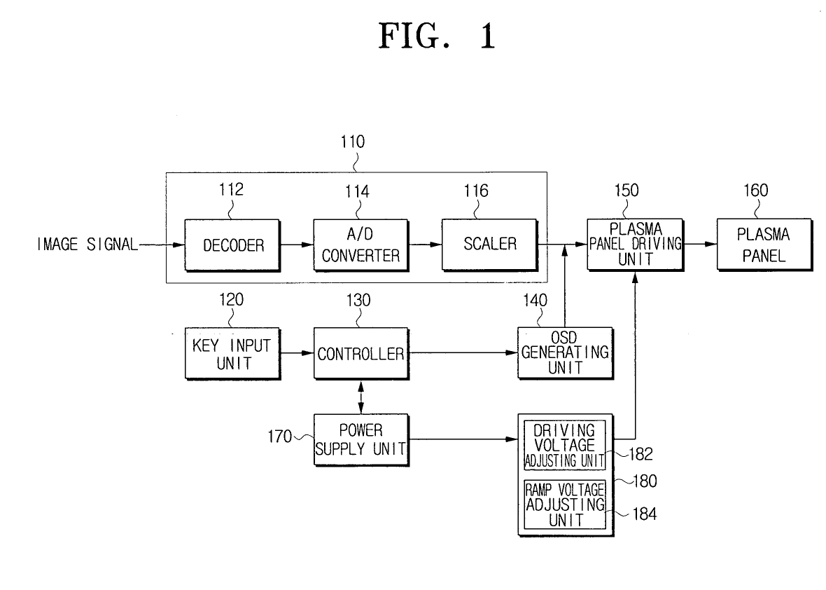

FIG. 1 is a block diagram illustrating a plasma display apparatus in accordance with an exemplary embodiment of the present invention.

The plasma display apparatus is one example of an image display apparatus which displays a discharge removal menu and removes discharge according to a discharge removal value selected by a user.

Referring to FIG. 1, the plasma display apparatus includes a signal processing unit 110, a key input unit 120, a controller 130, an On Screen Display (OSD) generating unit 140, a plasma panel driving unit 150, a plasma panel 160, a power supply unit 170 and a discharge removing unit 180.

The signal processing unit 110 processes an external input signal into a displayable image signal, and includes a decoder 112, an analog/digital (A/D) converter 114 and a scaler 116. In detail, the decoder 112 converts an image signal having an image format other than red/green/blue (RGB) format into an image signal having RGB format. The A/D converter 114 receives the image signal having the RGB format from the decoder 112, and converts the image signal into a digital signal. The scaler 116 adjusts the digital image signal from the A/D converter 114 according to a size of a screen.

The key input unit 120 includes a key for inputting a discharge removal menu display command, and a key for selecting a discharge removal value from the discharge removal menu. Here, a discharge removal menu key can be individually formed in the key input unit 120. When a discharge removal adjusting bar is displayed in the discharge removal menu in the vertical direction, up/down movement keys are used, and when the discharge removal adjusting bar is displayed in the discharge removal menu in the horizontal direction, right/left movement keys are used.

When the discharge removal menu display command is inputted through the key input unit 120, the controller 130 displays the discharge removal menu. In addition, the controller 130 removes the discharge according to the discharge removal value selected from the discharge removal adjusting bar by the key input unit 120.

When the discharge removal menu display command is inputted, the OSD generating unit 140 generates the discharge removal menu under the control of the controller 130. The discharge removal menu includes the discharge removal adjusting bar.

The plasma panel driving unit 150 receives the digital image signal converted by the scaler 116, and the discharge removal menu and the discharge removal adjusting bar generated by the OSD generating unit 140, and converts them into a signal for driving the plasma panel 160.

The plasma panel 160 displays the images, the discharge removal menu and the discharge removal adjusting bar according to the signal converted by the plasma panel driving unit 150.

The power supply unit 170 supplies a driving voltage to the plasma panel driving unit 150. The discharge removing unit 180 removes the discharge according to the discharge removal value selected from the discharge removal adjusting bar under the control of the controller 130, and includes a driving voltage adjusting unit 182 and a ramp voltage adjusting unit 184.

The driving voltage adjusting unit 182 adjusts the driving voltage according to the selected discharge removal value, and supplies the resulting voltage to the plasma panel driving unit 150, thereby removing the discharge. The ramp voltage adjusting unit 184 adjusts a boosting ramp gradient by adjusting a ramp voltage boosted in a reset period according to the selected discharge removal value, and supplying the resulting voltage to the plasma panel driving unit 150, thereby removing the discharge. In another situation, the ramp voltage adjusting unit 184 adjusts a dropping ramp gradient by adjusting a ramp voltage dropped in the reset period according to the selected discharge removal value, and supplying the resulting voltage to the plasma panel driving unit 150, thereby removing the discharge.

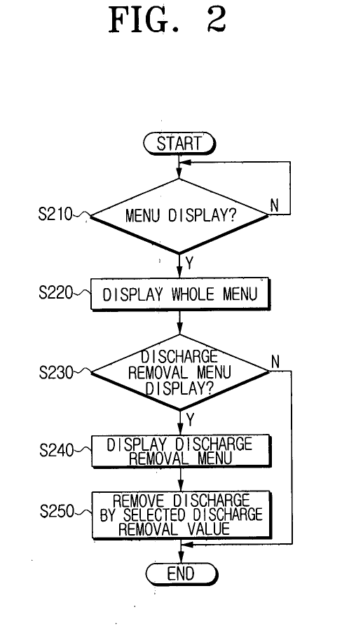

FIG. 2 is a flowchart showing sequential steps of the method for removing discharge of the plasma display apparatus in accordance with an exemplary embodiment of the present invention.

As shown in FIG. 2, the controller 130 decides whether a menu display command has been inputted (S210). The menu display command is inputted by a menu key of the key input unit 120.

When the menu display command has been inputted (S210-Y), the OSD generating unit 140 generates and displays the whole menu under the control of the controller 130 (S220). The whole menu includes various function menus of the plasma display apparatus, and is displayed on the plasma panel 160 by the plasma panel driving unit 150.

The controller 130 decides whether a discharge removal menu display command has been inputted (S230). The discharge removal menu display command is inputted when a discharge removal menu has been selected from the whole menu by the key input unit 120. In the case that a special discharge removal menu key is provided on the key input unit 120, the discharge removal menu display command can be inputted by the discharge removal menu key. If the discharge removal menu key is formed on the key input unit 120, S210 and S220 can be omitted.

When the discharge removal menu display command has been inputted (S230-Y), the OSD generating unit 140 generates and displays a discharge removal menu under the control of the controller 130 (S240). The discharge removal menu includes a discharge removal adjusting bar, and is displayed on the plasma panel 160 by the plasma panel driving unit 150.

Here, the discharge removal adjusting bar is divided into a range of numerical values, for example, 0 to 100. A value is selected by cursor movement using the key input unit 120.

The controller 130 controls the discharge removing unit 180 to remove the discharge according to the discharge removal value selected from the discharge removal adjusting bar (S250). The method for removing the discharge has been described with reference to FIG. 1, and thus detailed explanations thereof are omitted.

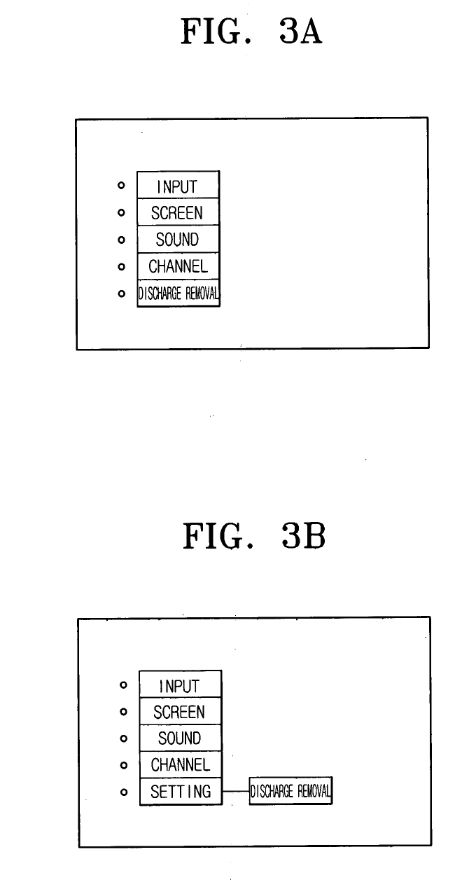

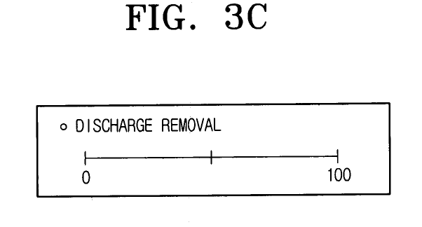

FIG. 3A is an exemplary diagram illustrating one example of the method for displaying the discharge removal menu in accordance with the present invention.

As depicted in FIG. 3A, the discharge removal menu is included in the whole menu, namely, the main menu. In this case, when the menu display command is inputted by the menu key of the key input unit 120, the OSD generating unit 140 generates and displays the main menu including the discharge removal menu under the control of the controller 130. When the discharge removal menu is selected by the up/down moving keys of the key input unit 120, the discharge removal adjusting bar is displayed.

FIG. 3B is an exemplary diagram illustrating another example of the method for displaying the discharge removal menu in accordance with the present invention.

As shown in FIG. 3B, the discharge removal menu is included in a sub menu of the main menu. When the menu display command is inputted by the menu key of the key input unit 120, the OSD generating unit 140 generates and displays the main menu under the control of the controller 130. Thereafter, when a setting menu is selected, the OSD generating unit 140 generates and displays sub menus of the setting menu including the discharge removal menu. When the discharge removal menu is selected, the discharge removal adjusting bar is generated and displayed.

FIG. 3C is an exemplary diagram illustrating one example of the method for displaying the discharge removal adjusting bar in accordance with an exemplary embodiment of the present invention.

Referring to FIG. 3C, when the discharge removal menu included in the main menu of FIG. 3A or the discharge removal menu included in the sub menu of FIG. 3B is selected, the discharge removal adjusting bar is displayed. In another case, if the discharge removal menu key of the key input unit 120 is inputted, the discharge removal adjusting bar is directly displayed.

The discharge removal adjusting bar can be displayed in the horizontal direction as shown in FIG. 3C, and also can be displayed in the vertical direction. In addition, the discharge removal adjusting bar can be displayed in a circular shape. One discharge removal adjusting bar can be displayed as shown in FIG. 3C, or three discharge removal adjusting bars such as a driving voltage adjusting bar, a boosting ramp voltage adjusting bar and a dropping ramp voltage adjusting bar can be displayed to correspond to the three methods for removing the discharge. In case one discharge removal adjusting bar is provided, the controller 130 controls the discharge removing unit 180 to remove the discharge by adjusting any one of the three elements according to the selected discharge removal value.

The value range of the discharge removal adjusting bar corresponds to variable ranges of the driving voltage, the boosting ramp voltage and the dropping ramp voltage. The value range is set as an optimum adjustable range. For example, when it is presumed that the variable range of the driving voltage ranges from 0 to 300 steps by digital conversion, it is too broad. Therefore, the value range is reduced to the range of 0 to 100 to correspond to 0 to 300 steps.

Accordingly, when the user selects the discharge removal value, the controller 130 controls the discharge removing unit 180 to remove the discharge according to the variable value corresponding to the selected discharge removal value.

As discussed earlier, in accordance with an exemplary embodiment of the present invention, the discharge removal menu is displayed, so that the user can directly conveniently remove the discharge.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. An image display apparatus, comprising:
a driving voltage adjusting unit which adjusts a driving voltage according to a selected discharge removal value;
a ramp voltage adjusting unit which adjusts a ramp voltage according to the selected discharge removal value; and
a controller which generates a discharge removal menu if a discharge removal menu display command is inputted, and controls at least one of the driving voltage adjusting unit and the ramp voltage adjusting unit to remove a discharge according to the discharge removal value selected from the discharge removal menu.

2. The image display apparatus as claimed in claim 1, further comprising an OSD generating unit which generates and displays the discharge removal menu.

3. The image display apparatus as claimed in claim 1, further comprising a key input unit which comprises at least one of a key for selecting the discharge removal menu on a menu screen, a special discharge removal menu key, and a key for selecting the discharge removal value.

4. The image display apparatus as claimed in claim 1, wherein the discharge removal menu comprises a discharge removal adjusting bar for adjusting the discharge removal value.

5. The image display apparatus as claimed in claim 4, wherein the discharge removal adjusting bar has an adjusting range corresponding to a variable range of a discharge removing element.

6. The image display apparatus as claimed in claim 5, wherein the discharge removing element is at least one of a driving voltage, a boosting ramp voltage for adjusting a boosting ramp gradient, and a dropping ramp voltage for adjusting a dropping ramp gradient.

7. A method for removing a discharge, the method comprising:
displaying a discharge removal menu if a discharge removal menu display command is inputted; and
removing a discharge according to a discharge removal value selected from the discharge removal menu.

8. The method as claimed in claim 7, wherein the discharge removal menu comprises a discharge removal adjusting bar for adjusting the discharge removal value.

9. The method as claimed in claim 8, wherein the discharge removal adjusting bar has an adjusting range corresponding to a variable range of a discharge removing element.

10. The method as claimed in claim 9, wherein the discharge removing element is at least one of a driving voltage, a boosting ramp voltage for adjusting a boosting ramp gradient, and a dropping ramp voltage for adjusting a dropping ramp gradient.
